(19) United States
(12) Patent Application Publication
(10) Pub. No.: US 2026/0120965 A1
(43) Pub. Date: Apr. 30, 2026

(54) NANO-SUPERCAPACITOR AND METHOD OF MANUFACTURING THE SAME

(71) Applicants: HYUNDAI MOTOR COMPANY, Seoul (KR); KIA CORPORATION, Seoul (KR)

(72) Inventors: Dae-Sung KWON, Hwaseong-si (KR); Il-Seon YOO, Hwaseong-si (KR); Hyun-Soo KIM, Hwaseong-si (KR)

(21) Appl. No.: 19/081,664

(22) Filed: Mar. 17, 2025

(30) Foreign Application Priority Data
Oct. 28, 2024 (KR) 10-2024-0148314

(51) Int. Cl. H01G 11/26; H01G 11/36; H01G 11/86

(52) U.S. Cl. CPC H01G 11/26; H01G 11/36; H01G 11/86

(57) ABSTRACT

A nano-supercapacitor includes a substrate on which a plurality of grating bars are disposed, an insulating layer disposed on the substrate, a plurality of first side surface electrodes disposed on the insulating layer on first side surfaces of the plurality of grating bars, a plurality of second side surface electrodes disposed on the insulating layers on second side surfaces of the plurality of grating bars, and a nanomaterial coated on surfaces of the plurality of first side surface electrodes and the plurality of second side surface electrodes. The nano-supercapacitor has an increased electrode surface area using a three-dimensional structure and a nanomaterial, and a uniform nanogap defined in a batch process.

### CROSS-REFERENCE TO RELATED APPLICATION

This application claims priority to Korean Patent Application No. 10-2024-0148314, filed on Oct. 28, 2024, the disclosure of which is incorporated herein by reference in its entirety.

### TECHNICAL FIELD

The present disclosure relates to a nano-supercapacitor and a method of manufacturing the same.

### BACKGROUND

Interdigital electrode (IDE) type nano-supercapacitors can be manufactured in the form of an IDE with a nano-scale gap using nano processes such as a focused ion beam (FIB).

IDE type micro supercapacitors (MSC) have advantages that ions can easily diffuse over the entire surface area of the device compared to a sandwich type electrode-based capacitor, a distance between two electrodes can be easily controlled, and a separator is not required.

In some cases, IDE type supercapacitors formed on a single plate may have better performance as an electrode surface area is larger and a distance between electrodes is narrower. In some cases, porous carbon-based electrodes (CNT) (graphene, activated carbon, etc.) may be used to increase an electrode surface area.

In some cases, the closer the distance between the electrodes, the shorter the distance that ions have to diffuse and move during charging/discharging, and there is the effect of widening an active area of the electrode.

In some cases, the development of a supercapacitor with better performance may be possible as a gap size is smaller, and when a supercapacitor with a nanogap is manufactured, performance improvement can be expected compared to conventional micro-gap supercapacitors.

In some cases, the supercapacitors with the nano-gap may include a nano-material such as MXene or CNT used to form a nano-gap to improve the performance of the capacitor, but most gap-forming processes utilize a serial process such as a FIB, making it difficult to mass-produce. It may be difficult to manufacture the supercapacitors in a structure that can maximize the electrode surface area, such as a three-dimensional structure.

In some cases, to increase the surface area, the electrode area can be increased by manufacturing the supercapacitors in a three-dimensional structure using a deep reactive-ion etching (DRIE) process, where it may be difficult to form a uniform nano-scale gap.

### SUMMARY

The present disclosure describes a nano-supercapacitor and a method of manufacturing the same, in which an electrode surface area can be maximized using a three-dimensional structure and a nanomaterial and a uniform nanogap can be formed using a batch process.

According to one aspect of the subject matter described in this application, a nano-supercapacitor includes a substrate including a plurality of grating bars disposed thereon, an insulating layer disposed on the substrate and the plurality of grating bars, a plurality of first side surface electrodes that are disposed on the insulating layer and that are disposed at first side surfaces of the plurality of grating bars, respectively, a plurality of second side surface electrodes that are disposed on the insulating layer by an evaporation process and that are disposed at second side surfaces of the plurality of grating bars, respectively, and a nanomaterial that is coated on surfaces of the plurality of first side surface electrodes and the plurality of second side surface electrodes.

Implementations according to this aspect can include one or more of the following features. For example, the nano-supercapacitor can further include a plurality of first upper surface electrodes that are disposed on the insulating layer and that are disposed at upper surfaces of the plurality of grating bars, respectively, each of the plurality of first upper surface electrodes being connected to one of the plurality of first side surface electrodes. The nano-supercapacitor can further include a plurality of second upper surface electrodes that are disposed on the insulating layer and that are disposed at upper surfaces of the plurality of grating bars, respectively, each of the plurality of second upper surface electrodes being connected to one of the plurality of second side surface electrodes.

In some examples, each of the plurality of first side surface electrodes can have a first extension that is disposed at a corresponding one of the plurality of grating bars, that extends toward a first end portion of the substrate, and that does not overlap with one of the plurality of second side surface electrodes disposed at the corresponding grating bar. Each of the plurality of second side surface electrodes can have a second extension that is disposed at the corresponding grating bar, that extends toward a second end portion of the substrate, and that does not overlap one of the plurality of first side surface electrodes disposed at the corresponding grating bar. In some examples, each of the plurality of first upper surface electrodes does not overlap with a corresponding one of the plurality of second side surface electrodes, where each of the plurality of second upper surface electrodes does not overlap with one of the plurality of first side surface electrodes.

In some implementations, the nano-supercapacitor can include a first electrode connected to the plurality of first upper surface electrodes and a second electrode connected to the plurality of second upper surface electrodes.

In some examples, a distance between (i) the first side surface electrode disposed at one of the plurality of grating bars and (ii) the second side surface electrode disposed adjacent to the first side surface electrode can be 100 nm or less. In some examples, the nanomaterial can include a carbon nanotube (CNT) or graphene.

According to another aspect, a method for manufacturing a nano-supercapacitor includes forming an insulating layer on a substrate including a plurality of grating bars disposed thereon, performing a first evaporation process to form a plurality of first side surface electrodes that are disposed on the insulating layer and that are disposed at first side surfaces of the plurality of grating bars, respectively, performing a second evaporation process to form a plurality of second side surface electrodes that are disposed on the insulating layer and that are disposed at second side surfaces of the plurality of grating bars, respectively, and coating surfaces of the plurality of first side surface electrodes and the plurality of second side surface electrodes with a nanomaterial.

Implementations according to this aspect can include one or more of the following features. For example, performing the first evaporation process can include forming a plurality of first upper surface electrodes that are connected to the plurality of first side surface electrodes, respectively, and that are disposed on the insulating layer, that are disposed at upper surfaces of the plurality of grating bars, respectively. Performing the second evaporation process can include forming a plurality of second upper surface electrodes that are connected to the plurality of second side surface electrodes, respectively, and that are disposed on the plurality of first upper surface electrodes, respectively.

In some implementations, the method can further include etching the first upper surface electrode and the second upper surface electrode that are disposed on each of the plurality of grating bars and overlap each other. In some examples, the plurality of first upper surface electrodes left in the etching do not overlap with the second side surface electrodes, and the plurality of second upper surface electrodes left in the etching do not overlap with the first side surface electrodes.

In some implementations, the method can further include forming a first electrode connected to the plurality of first upper surface electrodes, and forming a second electrode connected to the plurality of second upper surface electrodes. In some examples, a distance between (i) the first side surface electrode disposed at one of the plurality of grating bars and (ii) the second side surface electrode adjacent to the first side surface electrode can be 100 nm or less. In some examples, the nanomaterial can include a carbon nanotube (CNT) or graphene.

In some implementations, coating with the nanomaterial can include coating the substrate with a solution including the nanomaterial, coating the substrate with a nanomaterial protection masking layer after coating the substrate with the solution, etching a portion of the nanomaterial protection masking layer that is disposed on the upper surfaces of the plurality of grating bars, etching the nanomaterial that is exposed through the portion of the nanomaterial protection masking layer, and etching the nanomaterial protection masking layer that is left after etching the nanomaterial.

In some implementations, coating with the nanomaterial can include forming, by an evaporation process, a sacrificial layer on the substrate, coating the substrate with a solution including the nanomaterial, and removing the sacrificial layer. For examples, the sacrificial layer is not disposed on the plurality of first side surface electrodes and the plurality of second side surface electrodes. In some examples, removing the sacrificial layer can include removing the sacrificial layer by providing an etchant through the nanomaterial.

In some implementations, the supercapacitor can be manufactured by coating the IDE electrode with the nano material, and it can be possible to improve the performance of the capacitor by maximizing the electrode area and uniformly forming the nano-sized gap on the wafer scale.

In some implementations, it can be possible to manufacture the capacitor on the large-area wafer in the batch process through a process of coating the IDE electrode having the uniform nanogap with a solution.

In some implementations, since the IDE electrode of the present disclosure is manufactured by evaporating the thin film on the sidewall of the nanograting pattern, it is possible to greatly increase the electrode area within the same footprint area compared to the electrode evaporated on the flat surface, thereby improving the performance of the capacitor.

### BRIEF DESCRIPTION OF THE DRAWINGS

FIG. 1 illustrates an example of a nano-supercapacitor of the present disclosure.

FIG. 2 illustrates a cross-section along line X-X in FIG. 1.

FIGS. 3 to 22 illustrate an example process of forming an electrode in a method of manufacturing a nano-supercapacitor of the present disclosure.

FIG. 23 is a partially enlarged view of FIG. 20.

FIG. 24 illustrates a state in which a nanomaterial is patterned based on FIG. 23.

FIGS. 25 to 29 sequentially illustrate an example of a process of patterning a nanomaterial in the method of manufacturing a nano-supercapacitor of the present disclosure.

FIGS. 30 to 32 sequentially illustrate another example of the process of patterning a nanomaterial in the method of manufacturing a nano-supercapacitor of the present disclosure.

### DETAILED DESCRIPTION

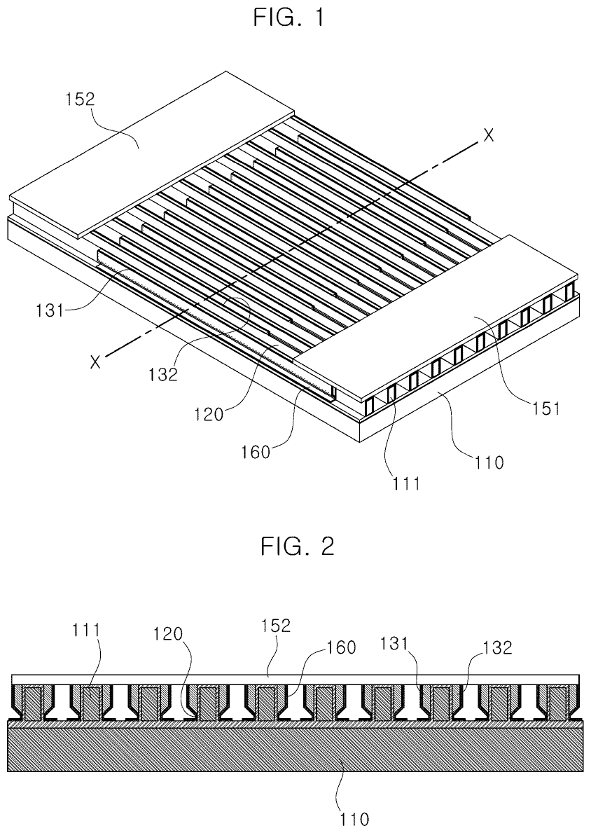

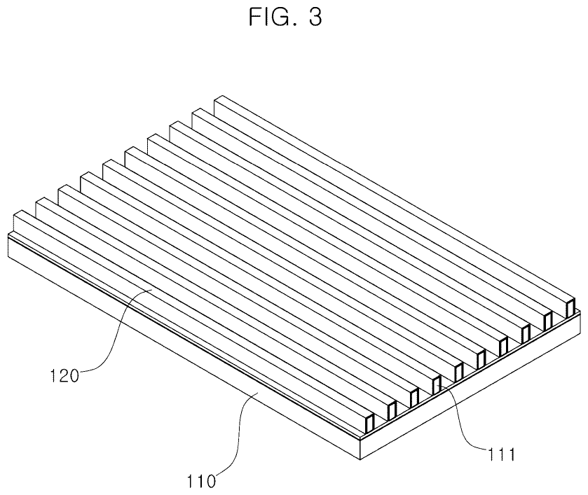

FIG. 1 illustrates an example of a nano-supercapacitor of the present disclosure, and FIG. 2 illustrates a X-X cross-section in FIG. 1.

Hereinafter, a nano-supercapacitor according to one embodiment of the present disclosure will be described with reference to FIGS. 1 and 2.

The present disclosure provides a nano-supercapacitor that can further improve performance of the capacitor by maximizing an electrode surface area using a three-dimensional structure and a nanomaterial and forming a uniform nanogap in a batch process.

Since the nano-supercapacitor of the present disclosure can be manufactured by coating an interdigital electrode (IDE) electrode having a nanogap with a nanomaterial, it is possible to improve performance of the capacitor by maximizing an electrode area and uniformly forming a nano-sized gap on a wafer scale.

In some implementations, uneven grating bars 111 formed to extend in one direction and arranged to be spaced apart in the other direction is formed on an Si nanograting substrate 110 of the present disclosure, a metal thin film is evaporated on the grating bars 111 to manufacture an interdigital electrode (IDE), and a surface of the IDE is coated with a nanomaterial such as a carbon nanotube (CNT) or graphene, which is used as a supercapacitor.

An insulating layer 120 such as SiO₂ or Si₃N₄ is formed on the nanograting substrate 110, and a first electrode 151 and a second electrode 152 are each formed on one of both end portions, which face each other, of the nanograting substrate 110.

The first electrode 151 is connected to a first side surface electrode 131 and a first upper surface electrode 141 that are formed on the grating bar 111, and the second electrode 152 is connected to a second side surface electrode 132 and a second upper surface electrode 142 that are formed on the grating bar 111.

In addition, the formed electrode and insulating layer 120 are coated with a nanomaterial 160.

The first side surface electrode 131 is evaporated on the insulating layer 120 of a first side surface of the grating bar 111. In addition, the second side surface electrode 132 is evaporated on the insulating layer 120 of a second side surface that faces the first side surface of the grating bar 111.

In some examples, the nano-supercapacitor of the present disclosure is manufactured in the form of an IDE having a nanogap by evaporating a metal on a sidewall of the grating bar 111.

The first upper surface electrode 141 is connected to the first electrode 151 evaporated thereon by being connected to the first side surface electrode 131, evaporated on an upper surface of the grating bar 111, and formed on one end portion of the nanograting substrate 110.

The second upper surface electrode 142 is connected to the second electrode 152 evaporated thereon by being connected to the second side surface electrode 132, evaporated on the upper surface of the grating bar 111, and formed on the other end portion of the nanograting substrate 110.

In some examples, the first side surface electrode 131 extends further toward the first electrode 151 than the second side surface electrode 132 to form a first extension, and the second side surface electrode 132 extends further toward the second electrode 152 than the first side surface electrode 131 to form a second extension.

Therefore, the first extension of the first side surface electrode 131 is formed not to overlap the second side surface electrode 132 in a transverse cross section, and the second extension of the second side surface electrode 132 is formed not to overlap the first side surface electrode 131 in the transverse cross section.

Since the present disclosure uses a thin film evaporated on a wall surface of a lattice structure as an electrode, it is possible to manufacture an IDE-based capacitor having a large surface area compared to a footprint area and manufacture a uniform nanogap through a batch process without using a process such as a FIB.

FIGS. 3 to 22 illustrate a process of forming an electrode in a method of manufacturing a nano-supercapacitor of the present disclosure, and FIGS. 25 to 32 illustrate a process of patterning a nanomaterial.

Hereinafter, a method of manufacturing a nano-supercapacitor according to one embodiment of the present disclosure will be described with reference to FIGS. 3 to 22 and FIGS. 25 to 32.

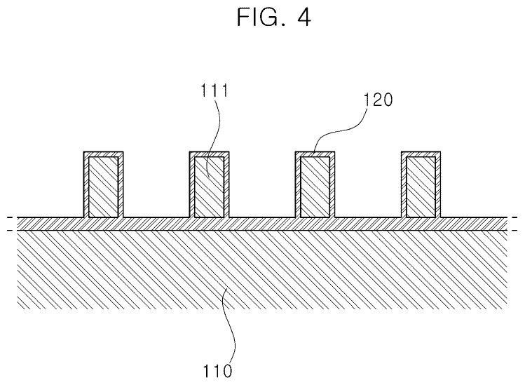

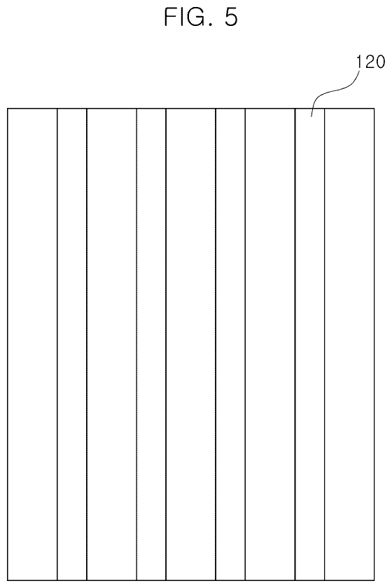

FIG. 3 illustrates a state in which the insulating layer 120 is formed on the nanograting substrate 110, FIG. 4 illustrates a cross-section along line \textcircled{1}-\textcircled{1} in FIG. 7, and FIG. 5 illustrates a flat surface in this case.

The insulating layer 120 such as SiO₂ or Si₃N₄ is formed using a process capable of forming an insulating layer conformally, such as thermal oxidation or chemical vapor deposition (CVD).

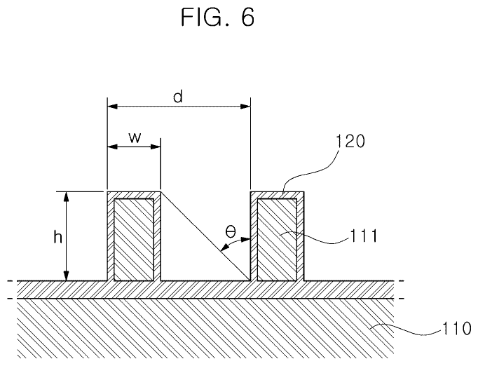

FIG. 6 illustrates a part of FIG. 4 and factors.

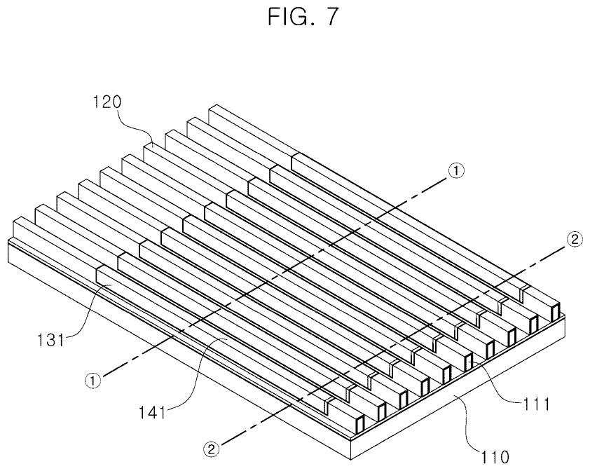

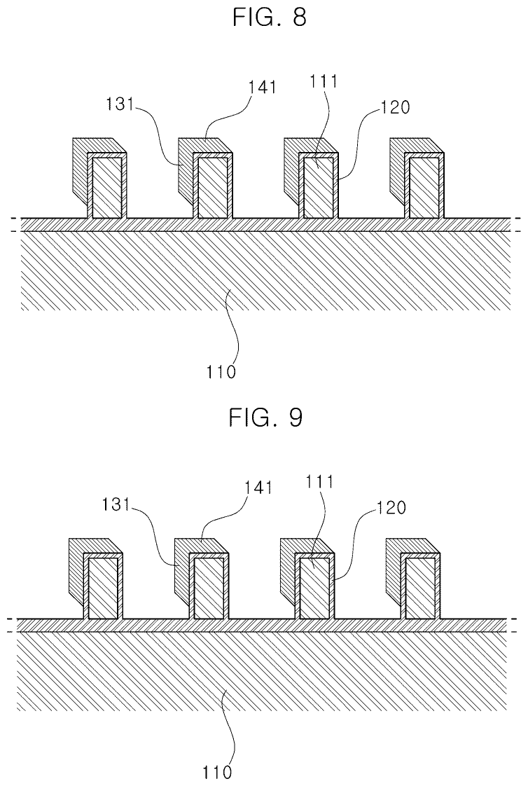

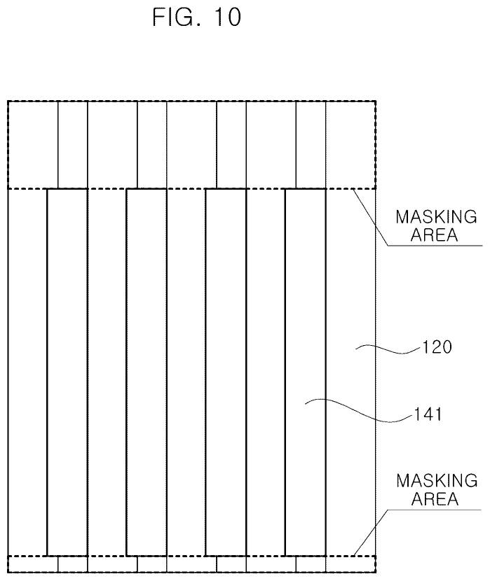

FIG. 7 illustrates a state in which the first side surface electrode and the first upper surface electrode are formed, FIG. 8 illustrates a cross-section along line \textcircled{1}-\textcircled{1} in FIG. 7, FIG. 9 illustrates a cross-section along line \textcircled{2}-\textcircled{2} in FIG. 7, and FIG. 10 illustrates a flat surface in this case.

A state in which the first side surface electrode 131 is formed on the first side surface of the grating bar 111 of the nanograting substrate 110 on which the insulating layer 120 is formed and the upper surface electrode is formed on the upper surface of the grating bar 111 is illustrated. The upper surface electrode is etched through subsequent etching so that only the first upper surface electrode 141 is left.

Referring to FIG. 6 together, evaporation is performed by slanting the substrate using an evaporation process with good directionality.

In this case, an angle θ at which a thin film evaporation substrate is slanted so that a metal can be evaporated on only one wall surface (the first side surface of the grating bar 111) and upper portion of an uneven structure is set in consideration of a height h, width w, and distance d of the uneven structure. That is, evaporation is performed by slanting the substrate at an angle greater than θ that satisfies tan θ=(d−w)/h.

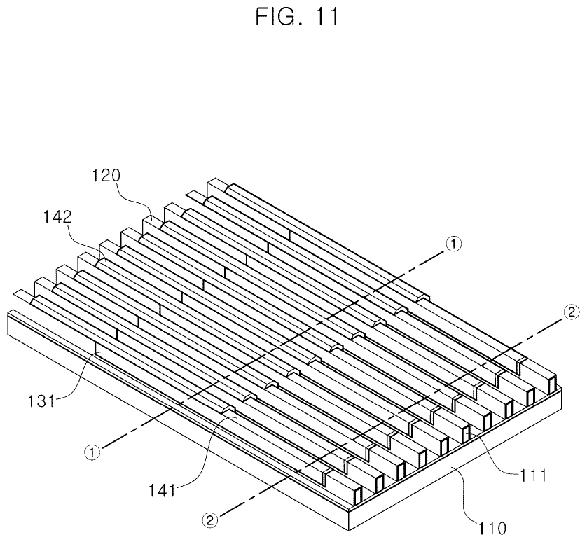

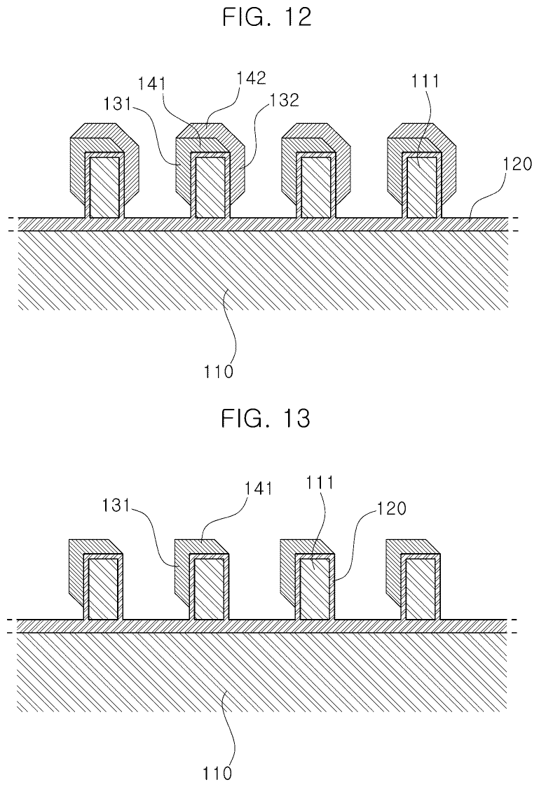

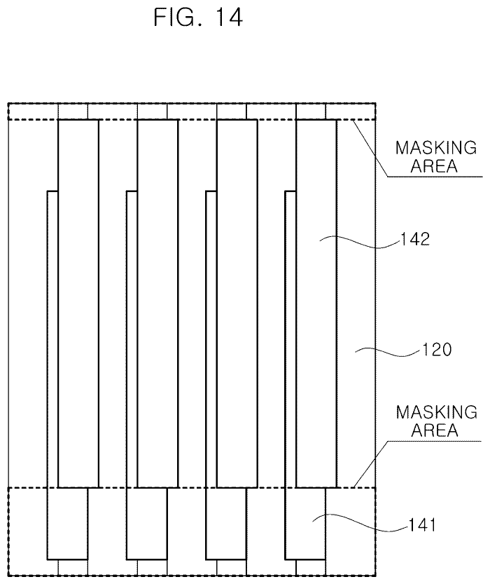

FIG. 11 illustrates a state in which the second side surface electrode and the second upper surface electrode are formed after the first side surface electrode and the first upper surface electrode are formed, FIG. 12 illustrates a cross-section along line \textcircled{1}-\textcircled{1} in FIG. 11, FIG. 13 illustrates a cross-section along line \textcircled{2}-\textcircled{2} in FIG. 11, and FIG. 14 illustrates a flat surface in this case.

A state in which the second side surface electrode 132 is formed on the second side surface of the grating bar 111 of the nanograting substrate 110 on which the insulating layer 120 is formed and the upper surface electrode is formed on the upper surface of the grating bar 111 is illustrated. The upper surface electrode is etched through subsequent etching so that only the second upper surface electrode 142 is left.

That is, as described above, evaporation is performed by slanting the substrate so that a metal can be evaporated on a wall surface, which is positioned at an opposite side, of the metal film evaporated on the first side surface.

The dotted lines in the drawing indicate a masking area.

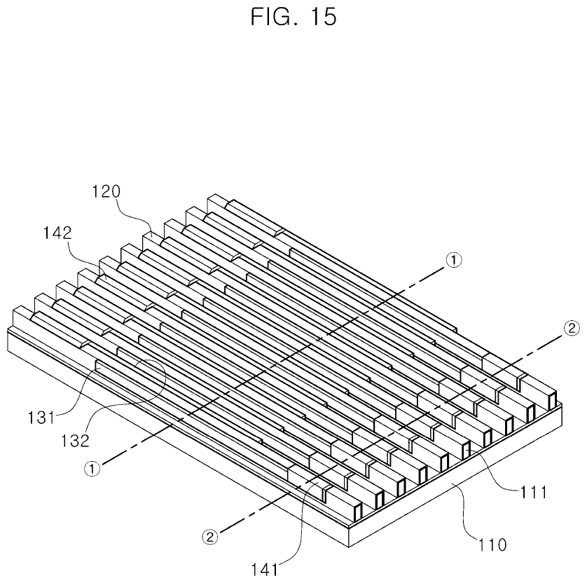

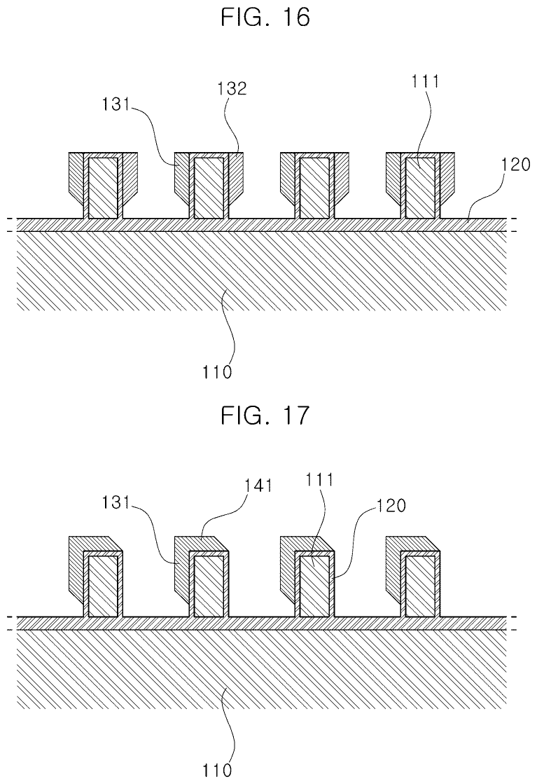

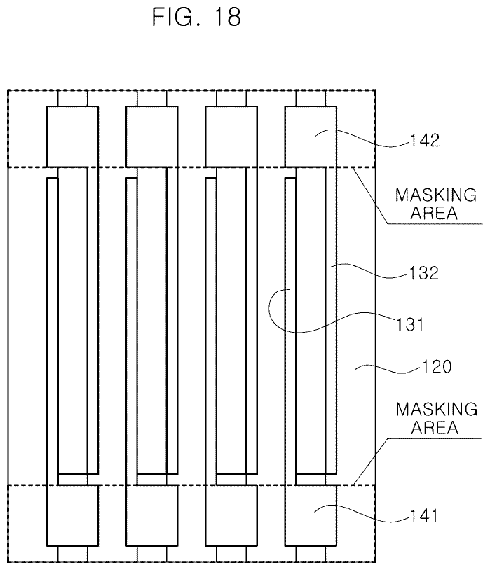

FIG. 15 illustrates a state in which the first upper surface electrode 141 and the second upper surface electrode 142 are formed by etching the upper surface electrode, FIG. 16 illustrates a cross-section along line \textcircled{1}-\textcircled{1} in FIG. 15, FIG. 17 illustrates a cross-section along line \textcircled{2}-\textcircled{2} in FIG. 15, and FIG. 18 illustrates a flat surface in this case.

For example, a metal film of the upper surface of the grating bar 111 formed in the previous process is etched through reactive ion etching (RIE) to form the first upper surface electrode 141 and the second upper surface electrode 142.

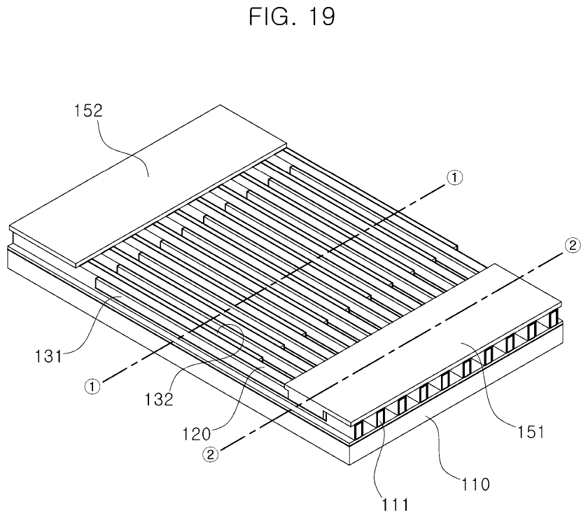

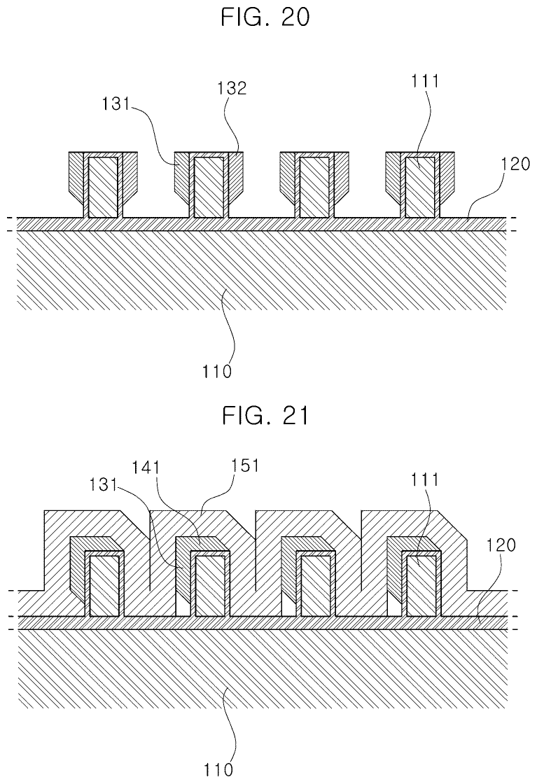

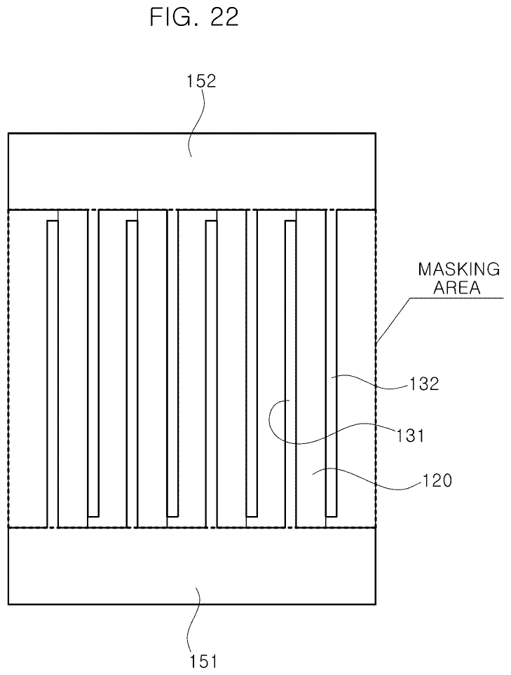

In addition, FIG. 19 illustrates a state in which the first electrode 151 is formed on a plurality of first upper surface electrode 141 and the second electrode 152 is formed on a plurality of second upper surface electrode 142, FIG. 20 illustrates cross-section along line \textcircled{1}-\textcircled{1} in FIG. 19, FIG. 21 illustrates cross-section along line \textcircled{2}-\textcircled{2} in FIG. 19, and FIG. 22 illustrates a flat surface in this case.

That is, the first electrode 151 and the second electrode 152 are formed through metal evaporation on a portion rather than the area in which an upper end was previously etched through RIE.

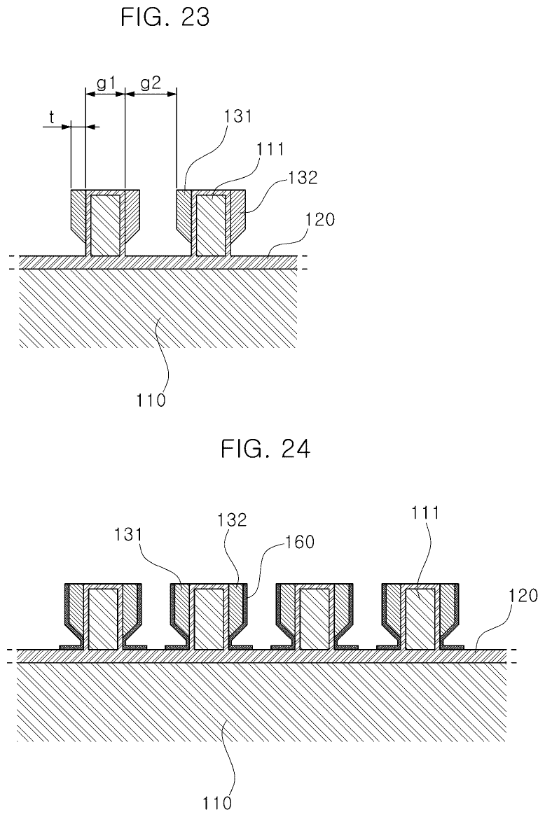

Referring to FIG. 23, which is a partially enlarged view of FIG. 20, the supercapacitor of the present disclosure can have a gap g2 of 100 nm or less when manufactured based on the nanograting manufacturing process, thereby implementing an IDE with a nanogap. In some examples, a width g1 of one grating bar 111 can be less than or equal to the gap g2. A thickness t of the first side surface electrode 131 and the second side surface electrode 132 can be less than g1.

In some examples, after the electrode is formed through the above process, as illustrated in FIG. 24, the nanomaterial 160 is formed on the formed electrode and insulating layer 120.

FIGS. 25 to 29 sequentially illustrate an example of a process of patterning a nanomaterial.

In one example, a method of patterning a nanomaterial uses etching, and as illustrated in FIG. 25, a solution in which a nanomaterial is dispersed is used to coat the entire surface of the substrate.

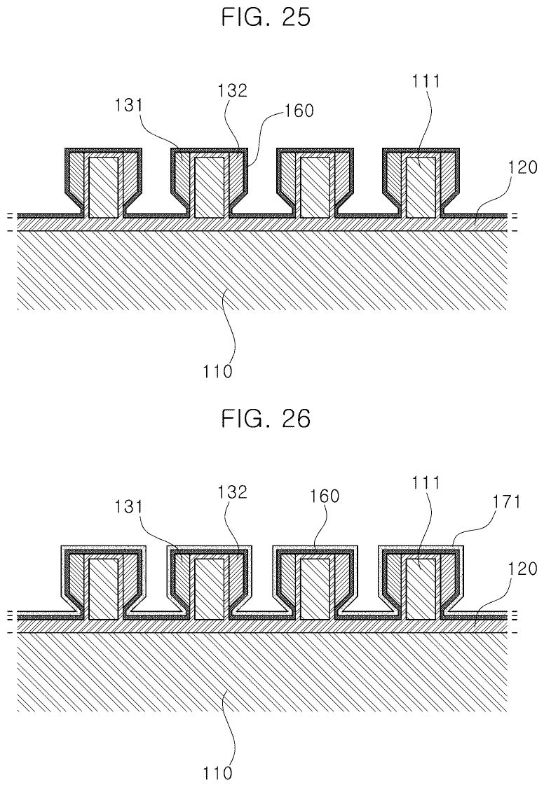

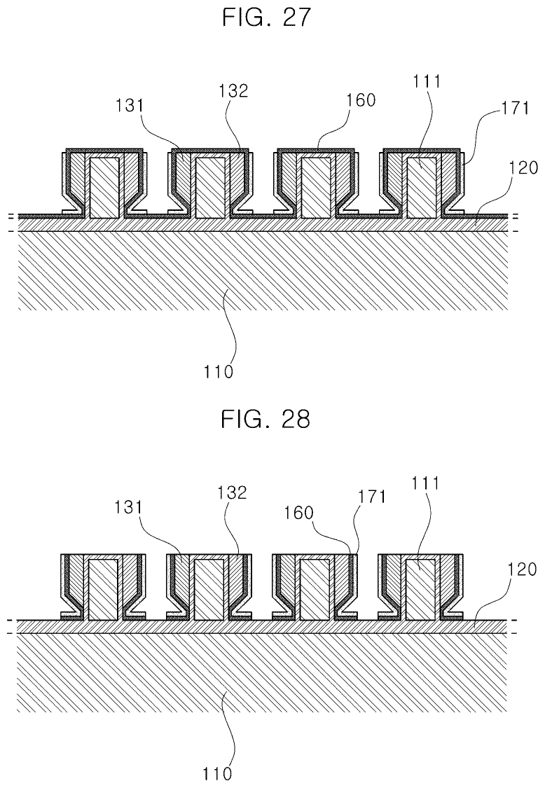

Then, as illustrated in FIG. 26, a nanomaterial protection masking layer 171 is coated (metal evaporation such as Cu or polymer coating is possible), and as illustrated in FIG. 27, the masking layer is etched. The nanomaterial protection masking layer 171 is partially etched by directional etching.

Furthermore, as illustrated in FIG. 28, the exposed nanomaterial is etched in a non-directional etching manner, and as illustrated in FIG. 29, a masking layer left after the nanomaterial etching is removed. In the case of Cu, wet etching, etc. may be used.

In some examples, the nanomaterial can be easily coated using the solution in which a nanomaterial is dispersed, and the coated nanomaterial such as CNT or graphene can be etched through O₂ plasma, etc., and the nanomaterial can be protected using the masking layer.

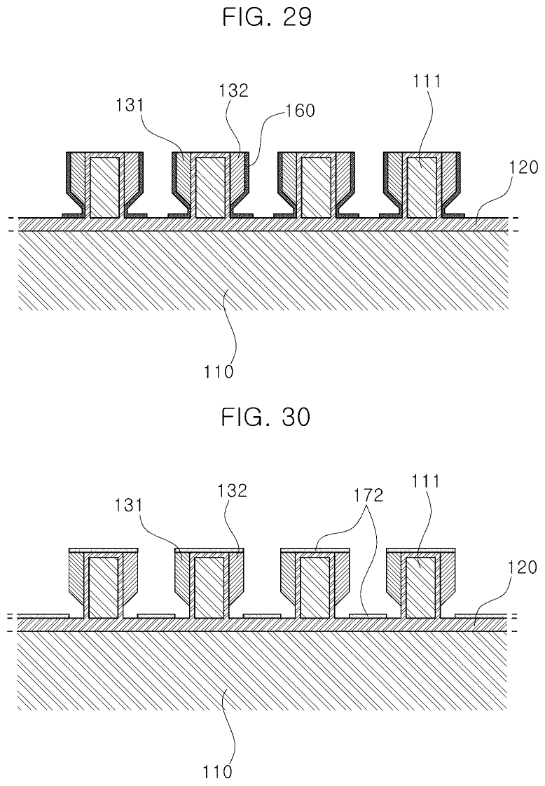

FIGS. 30 to 32 sequentially illustrate another example of the process of patterning a nanomaterial, which is a method using a lift-off process.

In some examples, as illustrated in FIG. 30, a sacrificial layer 172 is evaporated on the entire surface of the nanogap IDE.

Using an evaporation process with good straightness, the sacrificial layer 172 is evaporated so that a sacrificial layer material is not evaporated on the side surface electrode of the grating bar 111 with the uneven structure.

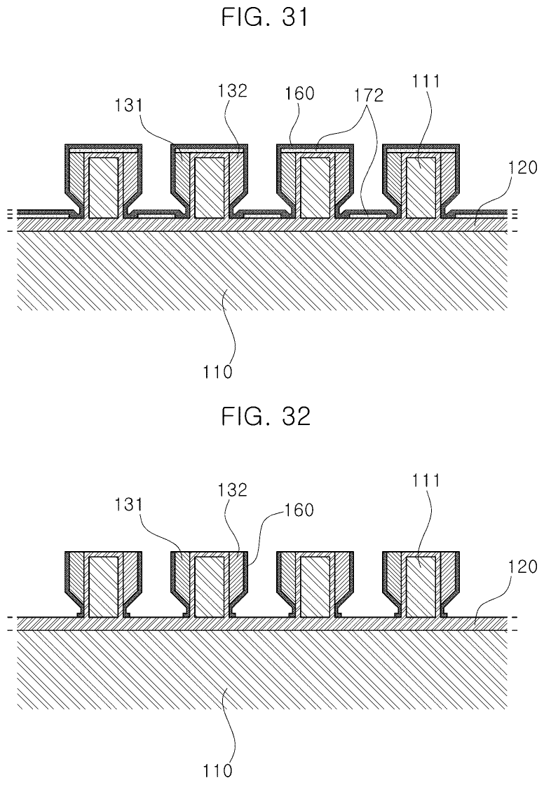

In some examples, as illustrated in FIG. 31, the above entire surface is coated with the nanomaterial 160 using a dispersion solution, and as illustrated in FIG. 32, the sacrificial layer is removed by penetrating an etchant between the nanomaterials 160 through lift-off.

In some implementations, the supercapacitor can be manufactured by forming the electrodes on the side surface portions of the grating bar and coating the electrodes with the nanomaterials, and since the metal thin film evaporated on the sidewall is used as the electrode, the IDE having a wider electrode surface area can be manufactured within the same footprint area compared to the case in which the IDE is formed on the substrate without nanograting patterns, and the performance of the supercapacitor can be improved due to the widened electrode surface area.

That is, it is possible to uniformly manufacture the distance between the IDE electrodes to 100 nm or less and manufacture a large-area wafer through a batch process.

Although the present disclosure has been described above with reference to the exemplary drawings, the present disclosure is not limited to the described embodiments, and it is apparent to those skilled in the art that various modifications and changes can be made without departing from the spirit and scope of the present disclosure. Therefore, these modified examples or changed examples should be included in the claims of the present disclosure, and the scope of the present disclosure should be construed based on the appended claims.

What is claimed is:

1. A nano-supercapacitor comprising:
a substrate including a plurality of grating bars disposed thereon;
an insulating layer disposed on the substrate and the plurality of grating bars;
a plurality of first side surface electrodes that are disposed on the insulating layer and that are disposed at first side surfaces of the plurality of grating bars, respectively;
a plurality of second side surface electrodes that are disposed on the insulating layer and that are disposed at second side surfaces of the plurality of grating bars, respectively; and
a nanomaterial that is coated on surfaces of the plurality of first side surface electrodes and the plurality of second side surface electrodes.

2. The nano-supercapacitor of claim 1, further comprising:
a plurality of first upper surface electrodes that are disposed on the insulating layer and that are disposed at upper surfaces of the plurality of grating bars, respectively, each of the plurality of first upper surface electrodes being connected to one of the plurality of first side surface electrodes; and
a plurality of second upper surface electrodes that are disposed on the insulating layer and that are disposed at upper surfaces of the plurality of grating bars, respectively, each of the plurality of second upper surface electrodes being connected to one of the plurality of second side surface electrodes.

3. The nano-supercapacitor of claim 2, wherein each of the plurality of first side surface electrodes has a first extension that is disposed at a corresponding one of the plurality of grating bars, that extends toward a first end portion of the substrate, and that does not overlap with one of the plurality of second side surface electrodes disposed at the corresponding grating bar, and
wherein each of the plurality of second side surface electrodes has a second extension that is disposed at the corresponding grating bar, that extends toward a second end portion of the substrate, and that does not overlap one of the plurality of first side surface electrodes disposed at the corresponding grating bar.

4. The nano-supercapacitor of claim 3, wherein each of the plurality of first upper surface electrodes does not overlap with a corresponding one of the plurality of second side surface electrodes, and
wherein each of the plurality of second upper surface electrodes does not overlap with one of the plurality of first side surface electrodes.

5. The nano-supercapacitor of claim 4, further comprising:
a first electrode connected to the plurality of first upper surface electrodes; and
a second electrode connected to the plurality of second upper surface electrodes.

6. The nano-supercapacitor of claim 4, wherein a distance between (i) the first side surface electrode disposed at one of the plurality of grating bars and (ii) the second side surface electrode disposed adjacent to the first side surface electrode is 100 nm or less.

7. The nano-supercapacitor of claim 4, wherein the nanomaterial comprises a carbon nanotube (CNT) or graphene.

8. A method for manufacturing a nano-supercapacitor, comprising:
forming an insulating layer on a substrate including a plurality of grating bars disposed thereon;
performing a first evaporation process to form a plurality of first side surface electrodes that are disposed on the insulating layer and that are disposed at first side surfaces of the plurality of grating bars, respectively;
performing a second evaporation process to form a plurality of second side surface electrodes that are disposed on the insulating layer and that are disposed at second side surfaces of the plurality of grating bars, respectively; and
coating surfaces of the plurality of first side surface electrodes and the plurality of second side surface electrodes with a nanomaterial.

9. The method of claim 8, wherein performing the first evaporation process comprises forming a plurality of first upper surface electrodes that are connected to the plurality of first side surface electrodes, respectively, and that are disposed on the insulating layer, that are disposed at upper surfaces of the plurality of grating bars, respectively, and
wherein performing the second evaporation process comprises forming a plurality of second upper surface electrodes that are connected to the plurality of second side surface electrodes, respectively, and that are disposed on the plurality of first upper surface electrodes, respectively.

10. The method of claim 9, further comprising etching the first upper surface electrode and the second upper surface electrode that are disposed on each of the plurality of grating bars and overlap each other.

11. The method of claim 10, wherein the plurality of first upper surface electrodes left in the etching do not overlap with the second side surface electrodes, and
wherein the plurality of second upper surface electrodes left in the etching do not overlap with the first side surface electrodes.

12. The method of claim 10, further comprising:
forming a first electrode connected to the plurality of first upper surface electrodes; and
forming a second electrode connected to the plurality of second upper surface electrodes.

13. The method of claim 10, wherein a distance between (i) the first side surface electrode disposed at one of the plurality of grating bars and (ii) the second side surface electrode adjacent to the first side surface electrode is 100 nm or less.

14. The method of claim 10, wherein the nanomaterial comprises a carbon nanotube (CNT) or graphene.

15. The method of claim 10, wherein coating with the nanomaterial comprises:
coating the substrate with a solution including the nanomaterial;
coating the substrate with a nanomaterial protection masking layer after coating the substrate with the solution;
etching a portion of the nanomaterial protection masking layer that is disposed on the upper surfaces of the plurality of grating bars;
etching the nanomaterial that is exposed through the portion of the nanomaterial protection masking layer; and
etching the nanomaterial protection masking layer that is left after etching the nanomaterial.

16. The method of claim 10, wherein coating with the nanomaterial comprises:
forming, by an evaporation process, a sacrificial layer on the substrate;
coating the substrate with a solution including the nanomaterial; and
removing the sacrificial layer.

17. The method of claim 16, wherein the sacrificial layer is not disposed on the plurality of first side surface electrodes and the plurality of second side surface electrodes.

18. The method of claim 16, wherein removing the sacrificial layer comprises removing the sacrificial layer by providing an etchant through the nanomaterial.
